(19) United States
(12) Patent Application Publication
(10) Pub. No.: US 2005/0173617 A1
(43) Pub. Date: Aug. 11, 2005

(54) Image forming apparatus

(75) Inventors: Takashi Deguchi, Sagamihara-shi (JP); Atsushi Suzuki, Tokyo (JP); Manabu Nakahanada, Tokyo (JP); Takeshi Saito, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/049,325

(22) Filed: Feb. 2, 2005

(30) Foreign Application Priority Data
Feb. 10, 2004 (JP) JP2004-033930

(51) Int. Cl. H01L 27/00

(52) U.S. Cl. 250/208.1

(57) ABSTRACT

An image forming apparatus comprises a recording head for exposing a printing sheet by emitting lights under a condition that an exposure amount of the lights for each pixel is independently controlled and adjusted, an exposure amount determining section for determining whether the exposure amount is within a predetermined range, and a first exposure amount adjusting section for adjusting the exposure amount based on a light emitting time of the lights table including a relationship between a light emitting time and the density of an image, wherein the first exposure amount adjusting section resets the light emitting time table based on a determination of the exposure amount determining section.

### FIELD OF THE INVENTION

The present invention relates to an image forming apparatus, particularly, to an image forming apparatus by which an image is formed while the density level is output-adjusted.

### BACKGROUND OF THE INVENTION

Conventionally, in an image forming apparatus for forming an image on a printing sheet by conducting digital exposure, there is provided a recording head for exposing a printing sheet after adjusting an exposure of each pixel for the image by emitting light under the condition each pixel is independently driven and controlled. In this exposure amount adjustment, used is a method by which the voltage or current of the recording head is varied and adjusted (for example, refer to the Patent Document 1), or a method by which the image data is converted by an output conversion LUT (Look Up Table) and adjusted (for example, refer to the Patent Document 2).
(Patent Document 1) Japanese Patent Application Open to Public: PaTokkai No. 2000-356830
(Patent Document 2) Japanese Patent Application Open to Public: Tokkaihei No. 10-327329

Herein, in the case that a method for adjusting an exposure is conducted by changing voltage or current of a recording head, for example, a fluorescent tube is used as a recording element of the recording head, it is structured in such a manner that the exposure amount is adjusted by varying the voltage. However, when the voltage is varied in this manner, although it is possible to adjust the exposure amount to obtain the target density level, there is a case where a color balance of RGB is not matched, since the print gradation is fluctuated in the low-density portion or high-density portion apart from the target density.

On the other hand, in the case where, an LED or a semiconductor laser element is used as a recording element of the recording head, it is structured in such a manner that the current is varied to adjust the exposure amount. In this case, although the shape of the curve of the print gradation vs current is smoother than the curve of gradation-voltage where the voltage is varied, still the exposure amount is sensitively varied to a change of the current. Accordingly, it is difficult to match it with a desired density level.

Further, in the case that a method for adjusting an exposure amount by the output-conversion LUT, when the exposure amount of the recording head is decreased by the aging deterioration, a signal range which has been used before the deterioration is narrowed. For example, even when the exposure amount is decreased to 50%, as the output conversion LUT to be used is the same as the one being used before the deterioration, the necessary density cannot be obtained. When the number of output gradation of the output conversion LUT is increased, the necessary density can be obtained, even though the exposure amount is decreased. However, it is not realistic from the viewpoint of processing time and cost.

### SUMMARY OF THE INVENTION

An object of the present invention is to provide an image forming apparatus by which optical density can be easily adjusted to a desired density level, even when the exposure amount of the recording head is decreased by the aging deterioration.

In the case where the voltage or current is varied to adjust exposure amount, the brightness of the recording element itself of the recording head is changed. Therefore, as described above, there is a problem that, in the low density portion or high density portion, the color balance of RGB is not matched each other, or it is difficult to adjust it to a desired density level. Herein, from the relationship of the exposure amount=brightness (light amount)×light emitting time, even when the brightness is not changed, when the light emitting time is changed, the exposure amount of the recording head can be adjusted. In the case where the exposure amount is adjusted by changing the light emitting time, the exposure amount is easily adjusted to a desired density level, since the exposure amount is not sensitively changed comparing with a case where the exposure amount is adjusted by changing the brightness.

That is, as in the image forming apparatus described above, the light emitting time table is reset based on the detection result of an exposure amount determining section, and when the light emitting time of the recording element is adjusted by using the light emitting time table being reset, even when the exposure amount of the recording head is decreased by the aging deterioration, the exposure amount can be increased, and further, can be easily adjusted to a desired density level.

In accordance another aspect of the present invention, an image forming apparatus comprises a recording head for exposing a printing sheet by emitting lights under a condition that an exposure amount of the lights for each pixel is independently controlled and adjusted, an exposure amount determining section for determining whether the exposure amount is in a predetermined range, a first exposure amount adjusting section for adjusting the exposure amount by changing at least one of values of a light emitting time table of the recording head, a current amount and a voltage amount applied to the recording head, and a second exposure amount adjusting section for adjusting a light emitting time of the light by using an output converting look up table for converting an input signal of the recording head into a signal corresponding to the recording head.

According to the present invention, since the first exposure amount adjusting section in which the exposure amount of the recording head is adjusted by changing at least one of the light emitting time table, current, voltage, and the second exposure amount adjusting section in which the light emitting time of the recording head is adjusted by converting the image data based on the output conversion LUT, are provided, the exposure amount of the recording head can be adjusted by jointly using these first exposure amount adjusting section and second exposure amount adjusting section. In this manner, when the first exposure amount adjusting section and second exposure amount adjusting section can be jointly used, even when the exposure amount of the recording head is decreased by the aging deterioration, after the exposure amount of the recording head is brought close to the vicinity of the target value by the first exposure amount adjusting section, it can be finely adjusted by the second exposure amount adjusting section. Therefore, the exposure amount of the recording head can be easily adjusted to the target value. As the result, the exposure amount can be adjusted to a desired density level.

In accordance anther aspect of the present invention the image forming apparatus described above, wherein the second exposure amount adjusting section resets the output converting look up table based on an adjustment result of the first exposure amount adjusting section after an exposure amount adjustment is conducted by the first exposure amount adjusting section.

In the case that the exposure amount is adjusted based on the output conversion LUT in the manner of the second exposure amount adjusting section, when the same output conversion LUT is used even though the exposure amount before the adjustment is different to adjust the exposure amount to the target value. However, according to the present invention, after the exposure amount adjustment is conducted by the first exposure amount adjusting section, as the output conversion LUT is reset based on the adjustment result of the first exposure amount adjusting section, the optimum output conversion LUT can be used to the adjustment result of the first exposure amount adjusting section, and as the result, the higher quality image can be formed.

In accordance with another aspect of the present invention, the image forming apparatus described above, wherein the judgment section determines that the first exposure amount adjusting section conducts an exposure amount adjustment, when the judgment section determines that detected results of a plurality of printing sheets by the exposure amount determining section are out of a predetermined range.

Even when the detection result of the exposure amount determining section in a single printing sheet is departed from a predetermined range, it is also considered that it is departed from a predetermined range due to a reason that the sensitivity of the printing sheet is low. In such a case, although the exposure amount of the recording head can be sufficiently secured, the exposure amount adjustment is unnecessarily conducted. Therefore, as in the present invention, only in the case where the detection result in a plurality of kinds of printing sheet of the exposure amount determining section is departed from a predetermined range, when the exposure amount adjustment by the first exposure amount adjusting section is conducted, it can be suppressed that the exposure amount adjustment is conducted unnecessarily.

According to the present invention, because the light emitting time table is reset based on the detection result of the exposure amount determining section, and the light emitting time of the recording element is adjusted by using the light emitting time table after the reset, even when the exposure amount of the recording head is decreased by the aging deterioration, the exposure amount can be increased, further, can be easily adjusted to a desired density level.

Further, when the first exposure amount adjusting section and the second exposure amount adjusting section are jointly used, even when the exposure amount of the recording head is decreased by the aging deterioration, after the exposure amount of the recording head is brought close to the vicinity of the target value, by the first exposure amount adjusting section, it can be finely adjusted by the second exposure amount adjusting section. Therefore, the exposure amount of the recording head can be easily adjusted to the target value, as the result, can be adjusted to a desired density level.

### BRIEF DESCRIPTION OF THE DRAWINGS

FIG. 1 is a schematic diagram showing an outline structure of an image forming apparatus of the present embodiment.

FIG. 2 is a schematic diagram showing an example of arrangement of recording elements of the recording head provided in the image forming apparatus in FIG. 1.

FIG. 3 is a block diagram showing an outline structure of a recording head control section provided in the image forming apparatus in FIG. 1.

FIG. 4(a)(b) are drawings used for an output conversion LUT.

FIG. 5 is a flowchart at the time when an exposure amount adjustment is conducted in the image forming apparatus in FIG. 1.

FIG. 6 is a group of charts showing the displacement of ESTm, EST(i) and EST(1) used in the image forming apparatus in FIG. 1, and the current value associated with the displacement.

FIG. 7 is a chart showing the current value set in a stepping shape, output conversion LUT corresponding to each of current values and the difference of EST for each step.

FIG. 8 is a flowchart when the exposure amount adjustment is conducted by selecting an appropriate table based on EST from the current values of each of stages shown in FIG. 7.

FIG. 9 is graphs showing the changes of the output conversion LUT when the light emitting time table is changed corresponding to the aging deterioration of the recording head.

FIG. 10 is a schematic diagram showing a modified example of the image forming apparatus in FIG. 1.

### DETAILED DESCRIPTION OF THE INVENTION

### The First Embodiment

Referring to the drawings, the first embodiment of the present invention will be detailed below. However, the scope of the invention is not limited to examples shown in the drawings.

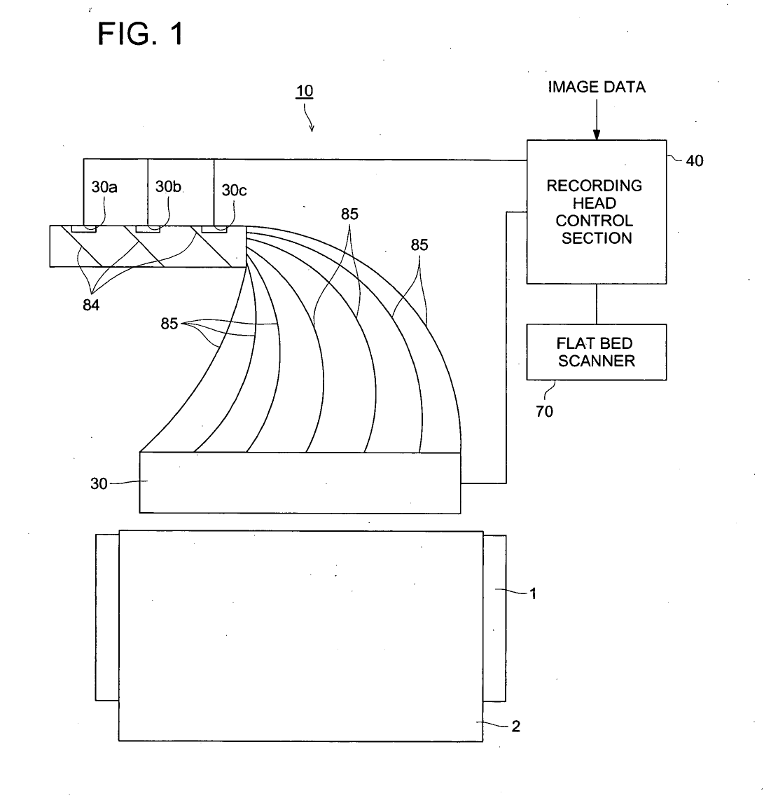

An outline structure of image forming apparatus 10 of the present invention is shown in FIG. 1. As shown in this figure, image forming apparatus 10 provides with a support drum 1.

The support drum 1 is rotated by a drive source (not shown), and conveys a color photographic printing sheet (hereinafter, called a printing sheet) 2 fed from a roller (not shown) in an arrow-ed direction. As printing sheet 2, a silver-halide photosensitive material is used.

Above support drum 1, PLZT type recording head 30 for exposing the printing sheet is provided. LED 30a, 30b, 30c for each color being light sources are connected to recording head 30 through a mirror 84 and an optical fiber 85. A plurality of recording elements (PLZT elements) is array-likely arranged along the main scanning direction on recording head 30, and the light from LED 30a, 30b and 30c are irradiated on printing sheet 2 on support drum 1. A polarizing plate is arranged on the optical path of these recording elements, and further, a minute lens group for image-forming the transmission light of each of recording elements on printing sheet 2 are provided. These recording element, polarizing plate and minute lens group function as an optical shutter. Then, on recording head 30, a shutter control circuit for driving each recording element is provided. In this shutter control circuit, a switch array circuit in which a semiconductor switch which switches whether the source voltage is applied on each recording element is integrated into one chip, and a drive circuit which drives each semiconductor switch for an open-close operation is provided. When each semiconductor switch is driven by the drive circuit, a pulse voltage is applied onto the electrode of each recording element.

When the voltage is applied on this electrode, the light transmitted to the recording element is irradiated, and brought into the light irradiated condition, and when the voltage is not applied on this electrode, the transmission of the light is shut-off and brought into the light irradiated stop condition. That is, this system is structured in such a manner that, the exposure amount is adjusted for each pixel by emitting lights under the condition that these recording elements being corresponding to each pixel are driven and controlled independently, and the image is recorded on printing sheet 2.

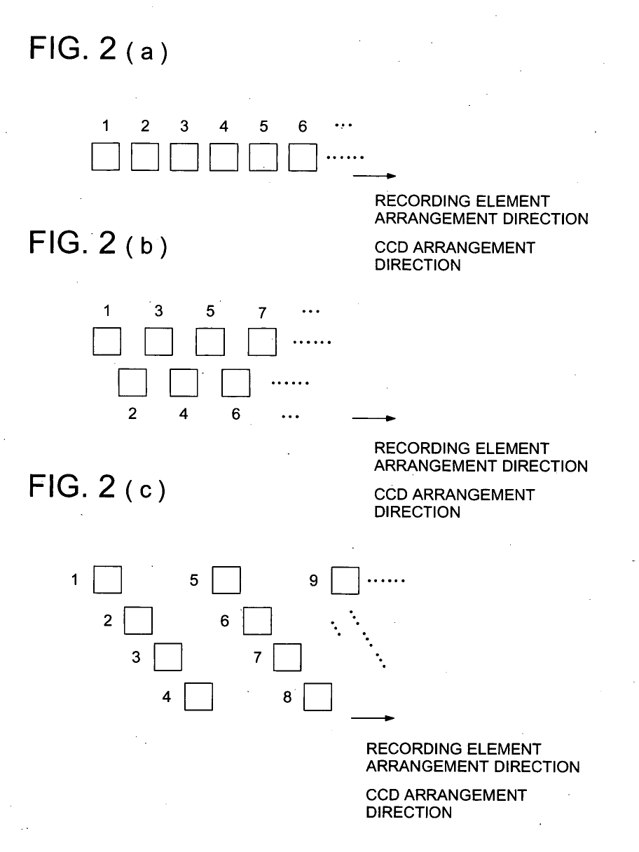

Herein, a phrase “array-like” includes not only “linear” as in FIG. 2(a), but also includes “zigzag arrangement as in FIG. 2(b), and an arrangement as in FIG. 2(c). Further, an arrangement direction of the recording element of the recording head is referred to, as shown in FIG. 2(a)-(c), a direction in which more recording elements are arranged. Hereinafter, for the purpose to conventionally separate the recording elements, the number is distributed to each of recording elements in order from 1 in the arrangement direction X.

As shown in FIG. 1, recording head control section 40 for conducting the control of recording head 30 is connected to recording head 30 so that the image data of each color of RGB is outputted at a predetermined position of printing sheet 2. Light source, CCD (Charge Coupled Device) and flat bed scanner 70 as an image reading device provided with an A/D converter are connected to recording head control section 40. Flat bed scanner 70 irradiates lights from the light source onto the image placed on a document table, and when its reflected light is converted into an electric signal (analog signal) by the CCD, the reading information is obtained. Then, flat bed scanner 70 converts the obtained reading information into digital data by A/D converter, and outputs it as image information to the recording head control section 40. Hereupon, CCD of flat bed scanner 70 is arranged array-like as shown in FIGS. 2(a)-2(c), in the same manner as the arrangement direction of the recording elements.

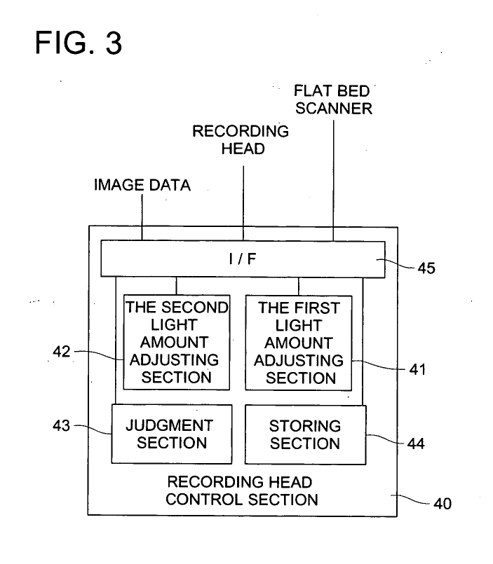

FIG. 3 is a block diagram of recording head control section 40. As shown in FIG. 3, in recording head control section 40, first exposure amount adjusting section 41 for adjusting the exposure amount of the recording head 30 when the current of LED 30a, 30b, 30c is changed, and the second exposure amount adjusting section 42 for adjusting the light emitting time of the recording head when the image data is converted based on output conversion LUT are provided. Further, in recording head control section 40, there are provided judgment device for determining whether first exposure amount adjusting section 41 needs to conduct an exposure adjustment and storing section 44 for storing each type of parameter necessary for the exposure amount adjustment. Then, in recording head control section 40, first exposure amount adjusting section 41, second exposure adjusting section 42, judgment section 43, storing section 44 and interface 45 to which a film scanner, a digital camera, an image data outputting device such as PC (Personal Computer), recording head 30 and flatbed scanner 70 which are an output source of the image data of the outside of the recording head control section 40.

In various kinds of parameters stored in the storing section 44, there are stored a test pattern data which is a reference at the time of the density measurement, output conversion LUT as a reference, a judgment range which is a judgment reference of judgment section 43, a plurality of printing sheet tables corresponding to the various kinds of printing sheet tables, and light emitting time table showing the relationship between the density of the image and the light emitting time for each type of printing sheet 2.

The test pattern data is the image data used for measuring the exposure amount of each of recording heads 30. On the basis of this test pattern data, the test pattern is formed on the printing sheet 2, and when the test pattern on the printing sheet 2 is read-in by the flat bed scanner 70, the density for each pixel is detected. From this detected density, the recording head control section 40 calculates the exposure amount of the recording head 30. That is, according to the present invention, the exposure amount determining section comprises flat bed scanner 70 and recording head control section 40.

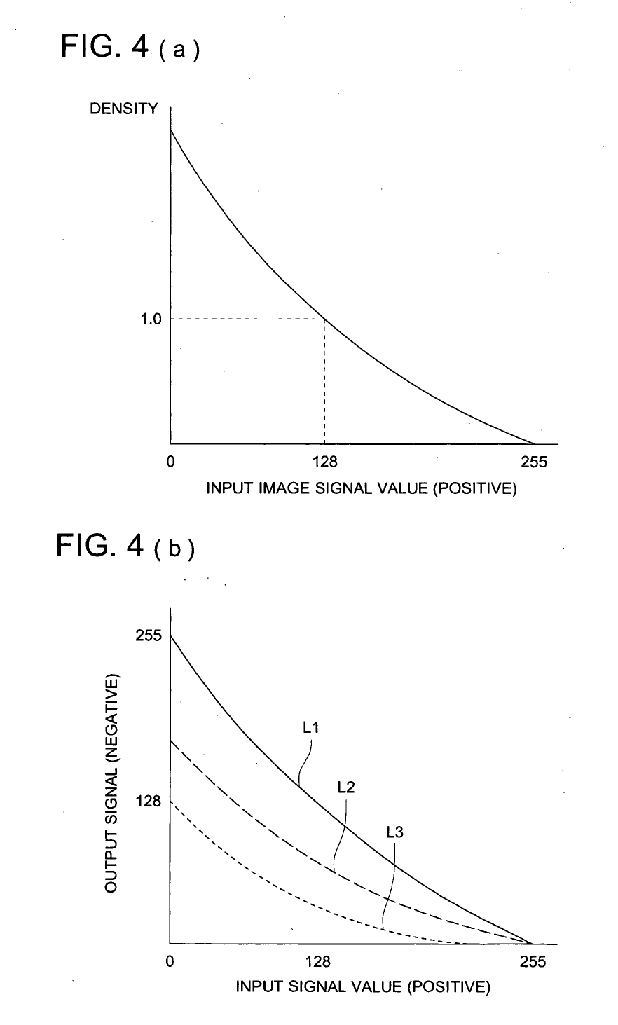

The output conversion LUT is one for converting an input signal value into a signal corresponding to the recording head 30. For example, there is a positive-negative conversion to convert a positive type image for recording into a negative type photosensitive material, or gradation conversion for converting into a desired gradation. In the present embodiment, the output conversion LUT having a function of the positive-negative conversion and the gradation conversion is provided. For example, as shown in FIG. 4(a), in the case where a system is applied in which, when a signal value outputted to the recording head 30 is 128, the density of the image is 1.0, when the brightness of the recording head 30 is lowered by the aging deterioration, even when the signal value is 128, the exposure amount the density 1.0 can not be obtained. From the relationship of exposure amount=brightness×light emitting time, even when the brightness is lowered, when the light emitting time is changed, the exposure amount which can realize the density 1.0 is obtained. As one of methods for changing this light emitting time, there is a method using the output conversion LUT. When the brightness of the recording head 30 is lowered, even though the signal value inputted into the recording head control section 40 is 128, the density 1.0 cannot be realized. If the signal value 128 is converted into a value which can realize the density 1.0 and outputted to the recording head 30, as the result, the density 1.0 can be realized. The output conversion LUT is an LUT which is used for this conversion of the signal value.

Herein, in the present embodiment, only the output conversion LUT as the reference is stored in the storing section 44, and in the case where the brightness of the recording head 30 is changed, when the output conversion LUT as the reference is multiplied by a coefficient corresponding to a change of the brightness, the output conversion LUT corresponding to the change of the brightness is made. For example, as shown in FIG. 4(b), in the case where the output conversion LUT as a reference is a solid line portion L1, when the coefficient corresponding to the change of the brightness is multiplied, the output conversion LUT such as a dotted line portion L2 or dotted line portion L3 can be made.

Hereupon, other than this, a plurality of output conversion LUTs corresponding to each of brightness values may also be previously stored in the storing section 44, or the recording head control section 40 may also make the output conversion LUT corresponding to each of brightness values.

The judgment range is a range in which, from the density obtained by reading-in the test pattern, the present exposure amount (average exposure amount) is calculated, and judgment section determines whether the calculated value exists in the range in which the image quality can be maintained.

A printing sheet table is a table which is owned one by one corresponding to the image quality, width of printing sheet 2, so that the exposure amount of recording head 30 is optimized corresponding to the type of printing sheet 2, when first exposure amount adjusting section 41 changes the current of the recording head 30. There are EST (Exposure Standard Table) of R, G, B, which will be described later and a current value in the printing sheet table.

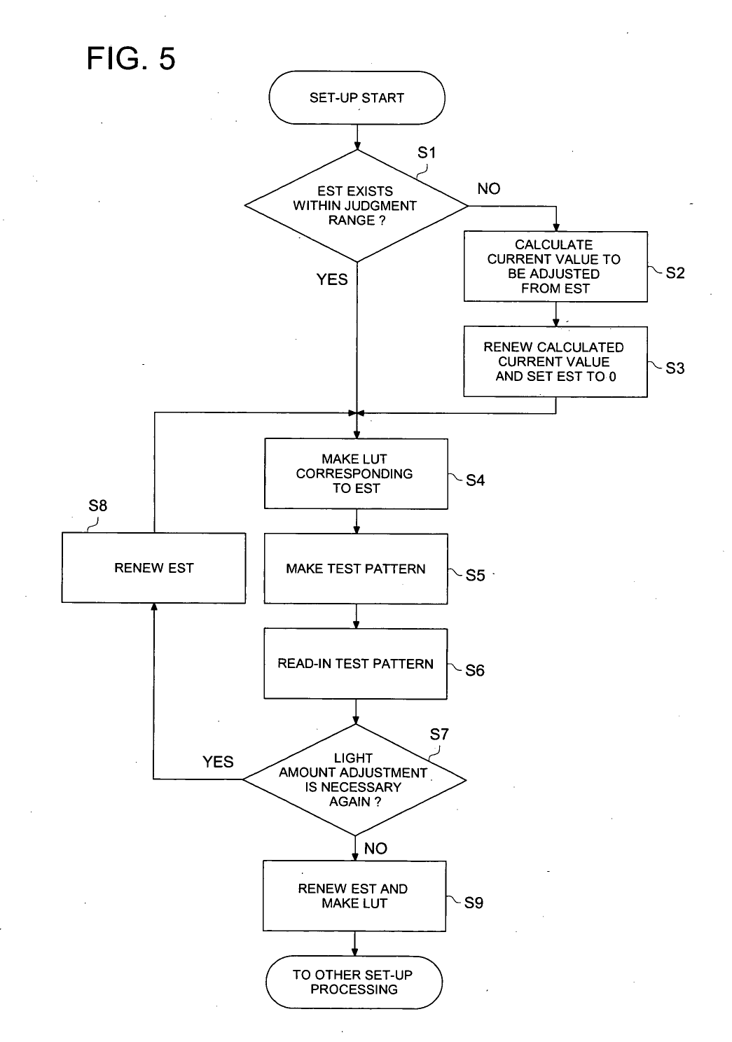

Next, referring to FIG. 5, an operation of image forming apparatus 10 of the present embodiment will be described. FIG. 5 is a flowchart at the time of exposure amount adjustment in the set-up processing. The set-up processing is a processing for conducting each type of adjustment of image forming apparatus 10 before the printing operation of every day. They are for example, the balance of RGB, density adjustment, exposure amount adjustment.

Initially, when the operator starts the set-up processing, recording head control section 40, as shown in FIG. 5, starts the set-up process. Herein, because the set-up processing is conducted before the printing operation of every day, EST of the day before is previously stored in the storing section 44. EST is a value obtained when the density of each pixel and a target density are compared to each other. The EST is a value in which the master channel ESTm for absorbing the light source variation or the level variation of the development processing which are not depending on the type of the printing sheet 2, and EST (i) of a plurality of paper channel (i) which is set for each of type of printing sheets 2 are added, and which is obtained for each colors of RGB. EST (R, G, B)=ESTm (R, G, B)+EST (i) (R, G, B).

In step S1, judgment section judges whether EST for each of colors of RGB is within the judgment range, when it is within the range, recording head control section 40 advances the sequence to step S4, and when it is out of the range, it advances the sequence to step S2.

In step S2, the current value to be adjusted is calculated based on EST, and the sequence advances to step S3.

In step S3, the calculated current value is renewed as an adjusted amount of the current by first exposure amount adjusting section 41, and EST is reset to 0, then the sequence advances to step S4. First exposure amount adjusting section 41 adjusts exposure amount of the recording head 30 based on the current value renewed herein.

In step S4, the output conversion LUT corresponding to EST is made, and re-set. Specifically, when 10^{(EST/1000)} is used as a coefficient and a reference output conversion LUT is multiplied by the coefficient, the output conversion LUT corresponding to EST can be made. Based on this output conversion LUT, the second exposure amount adjusting section 42 converts the image data and adjusts the exposure amount of the recording head 30.

When the output conversion LUT is made in step S4, recording head control section 40 advances the sequence to step S5, and controls recording head 30 based on the test pattern data, and makes a test pattern on printing sheet 2.

When the test pattern is made, an operator places printing sheet 2 on flat bed scanner 70, and starts the reading-in of the test pattern (step s6). After that, recording head control section 40 advances to step S7, and when the density of each pixel read and detected by flat bed scanner 70 is largely different from target density, it judges that the exposure amount adjustment is necessary again, and advances to step S8, and when it is almost equal to the target density, it judges that the exposure amount adjustment is not necessary, and advances to S9. In the present embodiment, when the target density is 1.00 and the measurement result is within ±0.03, reading head control section 40 advances to step S9, and when it is out of this range, reading head control section 40 advances to step S8.

In step S8, recording head-control section 40 obtains EST by comparing the detected density of each pixel to the target density, and advances the sequence to step S4. Hereupon, even when EST exceeds the judgment range herein, the current value is not renewed.

In step S9, recording head control section 40 calculates EST and changes it based on the density of each pixel obtained in step S6 and the target density, and makes an output conversion LUT corresponding to the changed EST. Then, recording head control section 40 stores the changed EST and the output conversion LUT in the storing section 44. EST stored in storing section 44 herein is used for the set-up processing of next day. After that, the sequence advances to the other set-up processing.

In this manner, when the exposure amount adjustment is conducted in the initial stage of the set-up processing, the time period of whole set-up processing can be more reduced than a case where the exposure amount adjustment is conducted on the process of the other set-up processing.

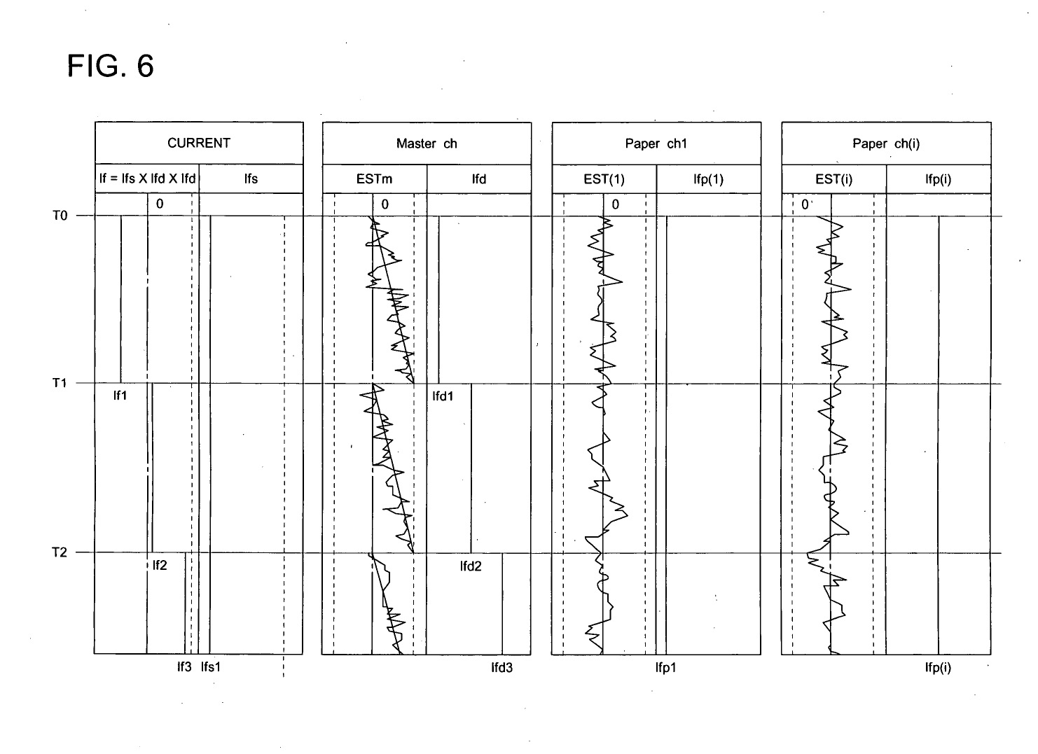

FIG. 6 is a group of charts showing the displacement of ESTm, EST(i) and EST(1) used in the image forming apparatus and the current value associated with the displacement. In FIG. 6, a vertical axis represents time. Herein, the current value If given to the recording head 30 is a value obtained when the initial value Ifs of the recording head 30, coefficient Ifd set in the master channel, and coefficient Ifp set for each of type of printing sheet 2 are multiplied each other. Hereupon, for the coefficient Ifp, when the type of used printing sheet 2 is recognized, it is obtained based on the printing sheet table. Further, when ESTm of the master channel is increased as time passes, and exceeds a predetermined value, the coefficient Ifd to be adjusted is calculated, and EST is reset to 0.

Then, in FIG. 6, when printing sheet 2 corresponding to paper channel 1 is used, current value If1 of time T0—time T1 is a value into which the current value Ifs1, coefficient Ifd1 and coefficient Ifp1 are multiplied, current value If2 of time T1−time T2 is a value into which current value Ifs1, coefficient Ifd2 and coefficient Ifp1 are multiplied, and current value If3 after time T2 is a value into which current value Ifs1, coefficient Ifd3 and coefficient Ifp1 are multiplied. Then, when the type of printing sheet 2 is changed, as Ifp(i) of paper channel (i) corresponding to the type is used, almost optimum current value can be obtained for each of type of printing sheet 2.

As described above, according to image forming apparatus 10 of the present embodiment, after the first exposure amount adjusting section 41 adjusts the exposure amount of the recording head 30 by changing the current, the second exposure amount adjusting section 42 adjusts the exposure amount of the recording head 30 by converting the image data based on the output conversion LUT. When first exposure amount adjusting section 41 and second exposure amount adjusting section 42 are jointly used and the exposure amount of recording head 30 is adjusted, even when exposure amount of recording head 30 is decreased by aging deterioration, after the exposure amount of recording head 30 is brought close to the vicinity of the target value by first exposure amount adjusting section 41, it can be finely adjusted by second exposure amount adjusting section 42. Therefore, the exposure amount of recording head 30 can be easily adjusted to the target value, and as the result, it can be adjusted to a desired density level.

Further, since the output conversion LUT is re-set based on the adjustment result of first exposure amount adjusting section 41, the output conversion LUT is optimized to the adjustment result of first exposure amount adjusting section 41 can be used, and as the result, the higher quality image can be formed.

Further, since first exposure amount adjusting section 41 switches the printing sheet table corresponding to the type of printing sheet to be used from printing sheet tables for each type, even when the type of printing sheet 2 is different, the exposure amount adjustment can be optimally conducted for each type of printing sheet 2.

### The Second Embodiment

Herein, in the first embodiment, a case where the exposure amount value to be adjusted by first exposure amount adjusting section 41 is calculated based on EST is described. In the second embodiment, a case where it is selectively used based on EST from a plurality of current values set stepwise, will be described. Hereupon, in the following description, for the same part as in the first embodiment, the same sign is affixed, and its description will be omitted.

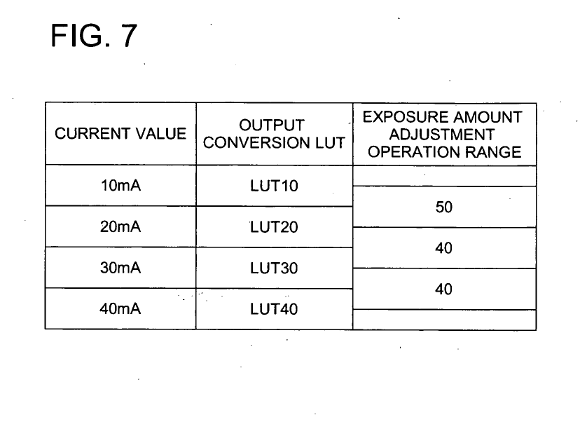

As in this second embodiment, when a current value is selected and used based on EST from a plurality of current values set stepwise, the difference of EST is set for each stage, and this difference is the judgment reference of the judgment section 43. This difference of EST is called an exposure amount adjustment operation range which is a judgment reference whether an exposure amount adjustment is conducted by the first exposure amount adjusting section 41. For example, as shown in FIG. 7, when the current values are prepared in 4-stages in every 10 mA, such as 10 mA, 20 mA, 30 mA, 40 mA in the case where respective exposure amount adjustment operation ranges are, when 10 mA and 20 mA, 50, when 20 mA and 30 mA, are 40, and when 30 mA and 40 mA, are 40, when the current value is 10 mA, it is not changed when the absolute value of the calculated EST is not larger than 50, and is changed when not smaller than 50. In the same manner, in the case where the current value is 20 mA, it is not changed when the absolute value of the calculated EST is not larger than 40, and is changed when not smaller than 40, and in the case where the current value is 30 mA, it is not changed when the absolute value of the calculated EST is not larger than 40, and is changed when not smaller than 40. Specifically, when the current value before the adjustment is 10 mA and EST is 60, since EST exceeds an exposure amount adjustment operation range (50) in 10 mA and 20 mA, the current value is increased by one stage to 20 mA, and EST is renewed to 60−50=10. In the same manner, when the current value before the adjustment is 20 mA and EST is 60, since EST exceeds the exposure amount adjustment operation range (40) in 20 mA and 30 mA, the current value is increased by one stage to 30 mA, and EST is renewed to 60−40=20. On the hand, when the current value before the adjustment is 10 mA and EST is 40, since EST does not exceed the exposure amount adjustment operation range (50) in 10 mA and 20 mA, also the current value and EST are remained as they are, in 10 mA and 40.

Further, in the present embodiment, the output conversion LUT optimum for the original current value for each current value is prepared. Therefore, even when the recording element whose output gradation is delicately differed by the current value is used, because the recording can be conducted in the gradation characteristic corresponding to each current value, the image quality is improved. For example, in FIG. 7, the reference output conversion LUT in 10 mA, is called LUT10, the reference output conversion LUT in 20 mA is called LUT20, the reference output conversion LUT in 30 mA is called LUT30, and the reference output conversion LUT in 40 mA is called LUT40.

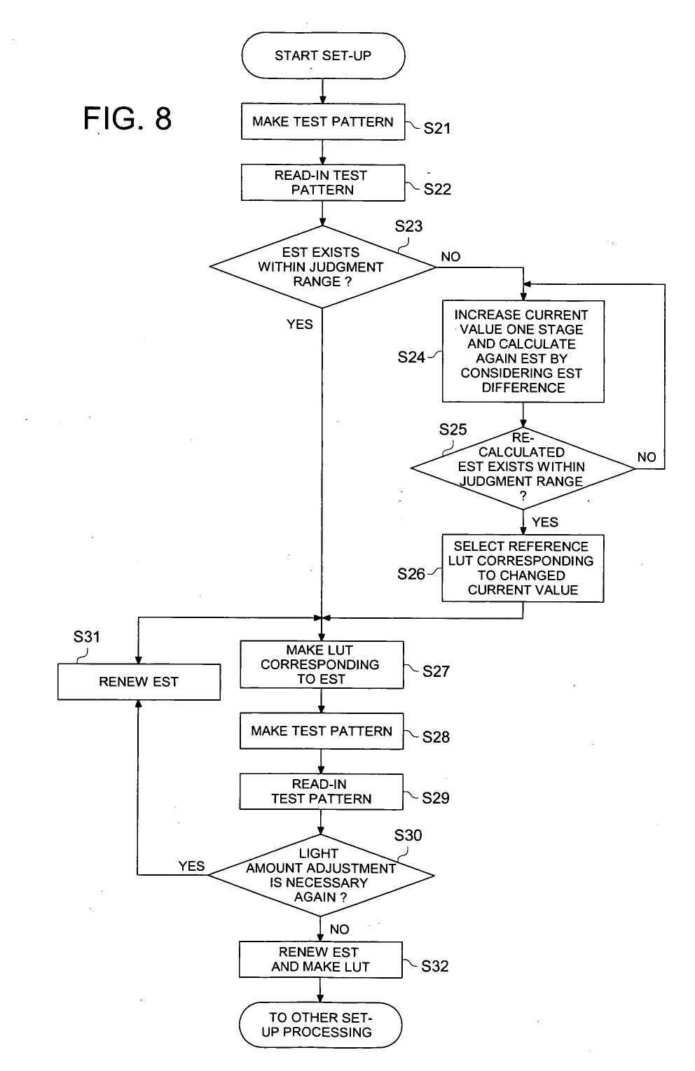

FIG. 8 is a flowchart of a case where the current value is selected from a plurality of current values being set stepwise based on EST and the exposure amount adjustment is conducted.

Initially, when the operator starts the set-up processing, recording head control section 40 advances to step S21, controls recording head 30 based on the test pattern data, and the test pattern is made via printing sheet 2.

When the test pattern is made, the operator places printing sheet 2 on the flat bed scanner 70, and starts the read-in of the test pattern (step S22). Recording head control section 40 obtains EST by comparing the density of each pixel which is read-in and detected by a flat bed scanner 70, to the target density.

When EST is obtained, recording head control section 40 advances to step S23, judgment section 43 judges whether EST is within the judgment range, and when it is within the judgment range, recording head control section 40 advances to step S27, and when it is out of the range, recording head control section 40 advances to step S24.

In step S24, the current value is increased by one stage and is re-calculated so as to be subtracted from EST by the difference corresponding to the stage, and recording head control section 40 advances to step S25.

In step S25, it is determined whether the re-calculated EST is within the judgment range, and when it is out of the range, recording head control section 40 advances to step S24, and when it is within the range, recording head control section 40 advances to step S26.

In step 26, the current value existing within the judgment reference is re-set as the adjustment value by first exposure amount adjusting section 41, and the reference output conversion LUT corresponding to this current value is selected, and recording head control section 40 advances to step S27.

In step S27, 10^{(EST/1000)} is set as a coefficient and the reference output conversion LUT is multiplied by the coefficient. Then the output conversion LUT corresponding to EST is made. Based on this output conversion LUT, the second exposure amount adjusting section 42 converts the image data and adjusts the exposure amount of the recording head 30.

When the output conversion LUT is made in step S27, the recording head control section 40 advances to step S28 and controls the recording head 30 based on the test pattern data, and makes the test pattern on the printing sheet 2.

When the test pattern is made, the operator places the printing sheet 2 on the flat bed scanner 70, and starts the reading-in of the test pattern (step S29). After that, the recording head control section 40 advances to step S30, and when the density of each pixel read and detected by flat bed scanner 70 is largely different from the target density, it judges that the exposure amount adjustment is necessary again, and advances to step S31. When the density of each pixel is almost equal to the target density, it judges that the exposure amount adjustment is not necessary, and advances to S32.

In step S31, recording head control section 40 obtains EST by comparing the detected density of each pixel to the target density, and advances to step S27. Hereupon, herein, even when EST exceeds the judgment range, the current value is not renewed.

In step S32, recording head control section 40 calculates EST and changes it based on the density of each pixel obtained in step S29 and the target density, and after making the output conversion LUT corresponding to the changed EST, it advances to the other set-up processing.

Hereupon, it is of course that the present invention can be appropriately changed, not limiting to the first and the second embodiments.

For example, in the above embodiment, although judgment section 43 judges whether the exposure amount adjustment is conducted by the first exposure amount adjusting section 41, based on EST obtained from the test pattern formed on a single printing sheet 2, when it is judged by only a single printing sheet 2, it is also considered that EST is out of the judgment range caused by that the sensitivity of the printing sheet 2 is low. In such a case, although the exposure amount of the recording head 30 is sufficiently secured, the exposure amount adjustment is unnecessarily conducted. Therefore, the test pattern is made on a plurality of kinds of printing sheets 2, and after the test pattern of each printing sheet 2 is read by the flatbed scanner 70, when all of EST of each printing sheet 2 obtained by comparing the density of each pixel of the test pattern in each printing sheet 2 to the target density are out of the judgment range, judgment section 43 determines that the exposure amount adjustment is conducted by first exposure amount adjusting section 41. In this manner, since the exposure amount adjustment is conducted by first exposure amount adjusting section 41 only when all of EST of each printing sheet 2 are out of the judgment range, it can be suppressed that the exposure amount adjustment is unnecessarily conducted.

Hereupon, even when the test patterns are not made on all of a plurality of types of printing sheets 2, when, for example, the result measured on printing sheet 2 corresponding to paper channel 1 is out of the judgment range, EST of the other paper channel is calculated newly, (for example, when it is paper channel 2, it is calculated by EST (R, G, B)=ESTm (R, G, B)+EST (2) (R, G, B)), and when the calculated result is out of the judgment range, the exposure amount adjustment by first exposure amount adjusting section 41 may also be conducted.

Further, even when the obtained EST is out of the judgment range only once, it is also considered that it is out of the judgment range due to the variation of the flat bed scanner 70 or the influence of development processing. In such a case, although the exposure amount of recording head 30 is sufficiently secured, the exposure amount adjustment is unnecessarily conducted. Therefore, when EST is out of the judgment range continuously for a predetermined period, judgment section 43 determines that the exposure amount adjustment by first exposure amount adjusting section 41 is conducted. In this manner, only when EST is out of the judgment range continuously for a predetermined period, when the exposure amount adjustment by first exposure amount adjusting section 41 is conducted, it can be suppressed that the exposure amount adjustment is unnecessarily conducted.

Further, in the above embodiment, a case where LED light source in which the light amount is changed when the current is changed is used as the recording element of recording head 30, is illustrated, however, as a recording element, it is not limited to this, for example, in the same manner as LED light source, the semiconductor laser element in which the exposure amount is changed when the current is changed, may also be used. Further, as a recording element, the fluorescent tube in which the light amount is changed when the voltage is changed, may also be used, however, in this case, it is necessary that first exposure amount adjusting section 41 changes the voltage of recording head 30 and adjusts the exposure amount. Further, in also the printing sheet table, when first exposure amount adjusting section 41 changes the voltage of the recording head, tabulated voltage value is used so that the exposure amount of the recording head after the adjustment is optimized for the type of printing sheet 2.

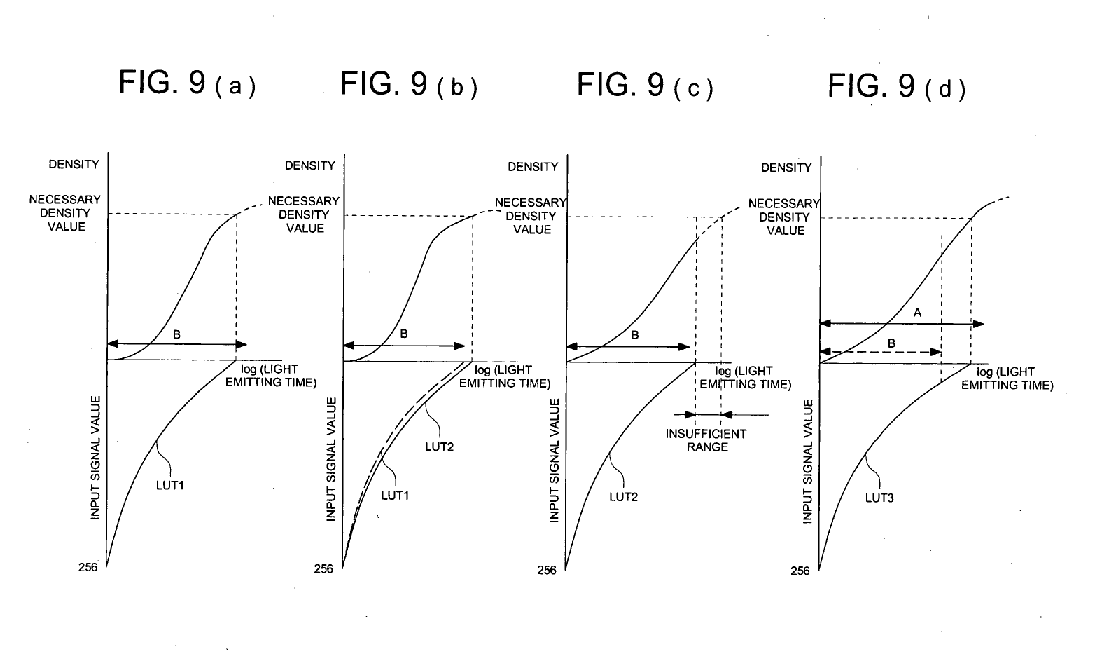

Herein, in the case where the exposure amount is adjusted by changing the voltage or current as described above, when the brightness of the recording element itself of recording head 30 is changed, the exposure amount is adjusted. Therefore, when the voltage is changed, there is a possibility that the balance of color such as RGB is not adjusted in the low density portion or high density portion. When the current is changed, there is a possibility that it becomes difficult to adjust the exposure amount to a desired density level. Hereupon, from the relationship of exposure amount=brightness×light emitting time, even though the brightness is not changed, also by a method by which the light emitting time is changed, the exposure amount of recording head 30 can be adjusted. Further, in the case where the light emitting time is changed and the exposure amount is adjusted, since there is no case where the exposure amount is more sensitively changed than a case where the brightness is changed and the exposure amount is adjusted, the exposure amount can be easily adjusted to a desired density level. From these reasons, it is preferable that the first exposure amount adjusting section 41 adjusts the exposure amount of recording head 30 based on the light emitting time table showing the relationship between the density of the image and the light emitting time. For example, in the case where two kinds of tables of the reference light emitting time table B and the light emitting time table A whose exposure amount is 25% larger than the light emitting time table B are prepared, when the light emitting time table B is set for first exposure amount adjusting section 41 before the exposure amount adjustment. In this case, because there is no deterioration and a sufficient brightness is secured for recording head 30, as shown in FIG. 9(a), the output conversion LUT1 as a basis is set so that a necessary density value can be obtained within the allowable range of the light emitting time table B. After that, as shown in FIG. 9(b), in the case where the brightness is lowered by the deterioration of the recording head 30 and not within the allowable range of the light emitting time table B, and necessary density value cannot be obtained, the output conversion LUT2 corresponding to the allowable limit is set. Then, as shown in FIG. 9(c), in the case where the deterioration is further advanced, and the density value necessary for the light emitting time table B can not be obtained, the first exposure amount adjusting section 41 re-sets the light emitting time table A. Hereby, because the light emitting time is extended and the exposure amount can be increased, as shown in FIG. 9(d), the output conversion LUT3 is set so that the necessary density value can be obtained.

In this manner, when the light emitting time table is re-set, and the light emitting time of the recording element is adjusted by using the light emitting time table after the re-set, even in the case where the exposure amount of recording head 30 is decreased by the aging deterioration, the exposure amount can be increased, and further, it can be easily adjusted to a desired density level.

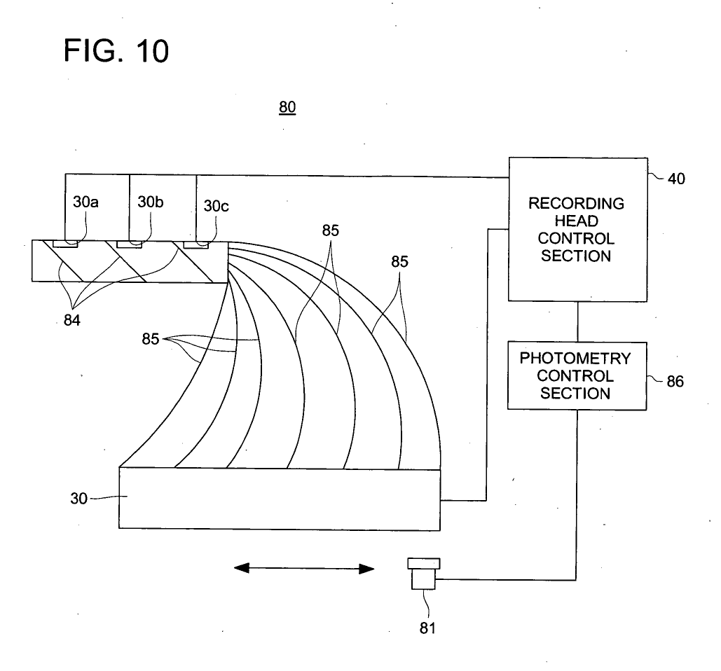

Further, in the above embodiment, a case where the exposure amount of recording head 30 is indirectly detected by using the exposure amount determining section structured by flatbed scanner 70 and recording head control section 40 is described. However, the exposure amount determining section is not limited to this, but the exposure amount determining section by which the exposure amount of the recording head is directly detected is also allowable. For example, in image forming apparatus 80 shown in FIG. 10, as exposure amount determining section, a photometry sensor 81 composed of, for example, CCD, is provided. This photometry sensor 81 measures the exposure amount corresponding to each pixel when it scans along the light emitting surface of the recording head 82. The detection result by the photometry sensor 81 is inputted into recording head control section 40 through photometry control section 86 which controls the photometry sensor 81. Hereby, recording head control section 40 can conduct the exposure amount adjustment based on the detection result of photometry sensor 81. In such a case, a predetermined output value of photometry sensor 81 is previously set as the reference value, and the exposure amount may also be adjusted based on the difference between the detected value and the reference value, or the previously measured result is maintained, and the exposure amount may also be adjusted based on the difference between the measured result of this time and the measured result of last time. Further, for example, from the table or conversion formula based on the input output characteristic of photometry sensor 81, recording head control section 40 may also adjust the exposure amount.

Then, also in the photometry sensor 81 or the flat bed scanner 70, since there is a possibility that it has aging deterioration, it is preferable that recording head control section 40 has a calibration function so that these aging changes can be adjusted. In this case, in order to consider the difference such as the developing processing, it is preferable that, for example, the correlation between the detected result of photometry sensor 81 and flatbed scanner 70 and the density is used.

1. An image forming apparatus, comprising:
a recording head for exposing a printing sheet by emitting lights under a condition that an exposure amount of the lights for each pixel is independently controlled and adjusted;
an exposure amount determining section for determining whether the exposure amount is within a predetermined range; and
a first exposure amount adjusting section for adjusting the exposure amount based on a light emitting time table;
wherein the first exposure amount adjusting section resets the light emitting time table based on a determination of the exposure amount determining section.

2. An image forming apparatus, comprising:
a recording head for exposing a printing sheet by emitting lights under a condition that an exposure amount of the lights for each pixel is independently controlled and adjusted;
an exposure amount determining section for determining whether the exposure amount is in a predetermined range;
a first exposure amount adjusting section for adjusting the exposure amount by changing at least one of values of a light emitting time table of the recording head, a current amount and a voltage amount applied to the recording head; and
a second exposure amount adjusting section for adjusting a light emitting time of the light by using an output converting look up table for converting an input signal of the recording head into a signal corresponding to the recording head.

3. The image forming apparatus of claim 2,
wherein the second exposure amount adjusting section resets the output converting look up table based on an adjustment result of the first exposure amount adjusting section after an exposure amount adjustment is conducted by the first exposure amount adjusting section.

4. The image forming apparatus of claim 2,
wherein the first exposure amount adjusting section selects one of table from various printing sheet tables including relationship between a printing sheet and an exposure amount of the first exposure amount adjusting section according to the printing sheet to be used in the image forming apparatus.

5. The image forming apparatus of claim 3,
wherein the first exposure amount adjusting section selects one of table from various printing sheet tables including relationship between a printing sheet and an exposure amount of the first exposure amount adjusting section according to the printing sheet to be used in the image forming apparatus.

6. The image forming apparatus of claim 3,
wherein the first exposure amount adjustment table is used for adjusting an exposure amount before an exposure amount adjustment is conducted based on the second exposure amount adjustment table.

7. The image forming apparatus of claim 4,
wherein the first exposure amount adjustment table is used for adjusting an exposure amount before an exposure amount adjustment is conducted based on the second exposure amount adjustment table.

8. The image forming apparatus of claim 5,
wherein the first exposure amount adjustment table is used for adjusting an exposure amount before an exposure amount adjustment is conducted based on the second exposure amount adjustment table.

9. The image forming apparatus of claim 1, further comprising:
a judgment section for determine whether an exposure amount adjustment by the first exposure amount adjusting section is needed,
wherein the first exposure amount adjusting section conducts an exposure amount adjustment based on a determination of the judgment section.

10. The image forming apparatus of claim 2, further comprising:
a judgment section for determine whether an exposure amount adjustment by the first exposure amount adjusting section is needed,
wherein the first exposure amount adjusting section conducts an exposure amount adjustment based on a determination of the judgment section.

11. The image forming apparatus of claim 6, further comprising:
a judgment section for determine whether an exposure amount adjustment by the first exposure amount adjusting section is needed,
wherein the first exposure amount adjusting section conducts an exposure amount adjustment based on a determination of the judgment section.

12. The image forming apparatus of claim 7, further comprising:
a judgment section for determine whether an exposure amount adjustment by the first exposure amount adjusting section is needed,
wherein the first exposure amount adjusting section conducts an exposure amount adjustment based on a determination of the judgment section.

13. The image forming apparatus of claim 8, further comprising:
a judgment section for determine whether an exposure amount adjustment by the first exposure amount adjusting section is needed,
wherein the first exposure amount adjusting section conducts an exposure amount adjustment based on a determination of the judgment section.

14. The image forming apparatus of claim 9,
wherein the judgment section determines that the first exposure amount adjusting section conducts an exposure amount adjustment, when the judgment section determines that detected results of a plurality of printing sheets by the exposure amount determining section are out of a predetermined range.

15. The image forming apparatus of claim 10,
wherein the judgment section determines that the first exposure amount adjusting section conducts an exposure amount adjustment, when the judgment section determines that detected results of a plurality of printing sheets by the exposure amount determining section are out of a predetermined range.

16. The image forming apparatus of claim 11,
wherein the judgment section determines that the first exposure amount adjusting section conducts an exposure amount adjustment, when the judgment section determines that detected results of a plurality of printing sheets by the exposure amount determining section are out of a predetermined range.

17. The image forming apparatus of claim 12,
wherein the judgment section determines that the first exposure amount adjusting section conducts an exposure amount adjustment, when the judgment section determines that detected results of a plurality of printing sheets by the exposure amount determining section are out of a predetermined range.

18. The image forming apparatus of claim 13,
wherein the judgment section determines that the first exposure amount adjusting section conducts an exposure amount adjustment, when the judgment section determines that detected results of a plurality of printing sheets by the exposure amount determining section are out of a predetermined range.

19. The image forming apparatus of claim 9, further comprising:
a recording head controller for controlling each section of the image forming apparatus,
wherein the recording head controller determines that the first exposure amount adjusting section conducts an exposure amount adjustment, when results of the judgment section continuously indicating that a detected result of the exposure amount determining section is out of a predetermined range for a predetermined time period.

20. The image forming apparatus of claim 10, further comprising:
a recording head controller for controlling each section of the image forming apparatus,
wherein the recording head controller determines that the first exposure amount adjusting section conducts an exposure amount adjustment, when results of the judgment section continuously indicating that a detected result of the exposure amount determining section is out of a predetermined range for a predetermined time period.

21. The image forming apparatus of claim 11, further comprising:
a recording head controller for controlling each section of the image forming apparatus,
wherein the recording head controller determines that the first exposure amount adjusting section conducts an exposure amount adjustment, when results of the judgment section continuously indicating that a detected result of the exposure amount determining section is out of a predetermined range for a predetermined time period.

22. The image forming apparatus of claim 12, further comprising:
a recording head controller for controlling each section of the image forming apparatus,
wherein the recording head controller determines that the first exposure amount adjusting section conducts an exposure amount adjustment, when results of the judgment section continuously indicating that a detected result of the exposure amount determining section is out of a predetermined range for a predetermined time period.

23. The image forming apparatus of claim 13, further comprising:
a recording head controller for controlling each section of the image forming apparatus,
wherein the recording head controller determines that the first exposure amount adjusting section conducts an exposure amount adjustment, when results of the judgment section continuously indicating that a detected result of the exposure amount determining section is out of a predetermined range for a predetermined time period.
